(19) United States
(12) Patent Application Publication
(10) Pub. No.: US 2013/0325531 A1
(43) Pub. Date: Dec. 5, 2013

(54) BUSINESS CASE DEVELOPMENT BY DYNAMICALLY REUSING BUSINESS CASE COMPONENTS

(71) Applicant: BART-JAN VAN PUTTEN, Dresden (DE)

(72) Inventor: BART-JAN VAN PUTTEN, Dresden (DE)

(21) Appl. No.: 13/484,237

(22) Filed: May 30, 2012

(51) Int. Cl. G06Q 10/00

(52) U.S. Cl. 705/7.11

(57) ABSTRACT

Various embodiments of systems and methods for supporting dynamic reuse of business case components in business case development are described herein. The method involves receiving a sample criterion for creating a new business case. A database of business cases is accessed where the criteria associated with the business cases are hierarchically structured according to a common data model. The method further includes comparing the sample criterion with the criteria associated with the business cases to identify one or more business cases that have a criterion matching the sample criterion. The method further includes scoring one or more criteria rendered alongside the matching criterion in the hierarchical structure, based on a position of the one or more criteria relative to a position of the matching criterion. Based on the scoring, one or more criteria having relatively higher scores are identified as additional criteria for the new business case.

### FIELD

The field relates generally to business case development (BCD). More specifically, the field relates to the dynamic reuse of business case components for business case development.

### BACKGROUND

For decades, determining the value and success of businesses has been high on the agendas of organizations. Many business related investments are strategic in nature, have long-term, hard to quantify benefits and incur indirect costs. Many investment projects cope with problems when having to identify the potential benefits of the investment, while a vast majority of them have problems with their quantification. This may lead to investment in the wrong projects, over-investment, under-investment, arid re-adjustment of estimates.

To support investment evaluation, in most organizations some kind of business case (BC) is developed. A business case is a recommendation to decision makers to take a particular course of action for the organization, supported by an analysis of benefits, costs and risks. Business case development (BCD) is the process of realizing the BC as an ‘artefact’, by gathering and analyzing data to define and valuate evaluation criteria, presenting it in documents, spreadsheets or presentations. It may take place before project execution for investment appraisal, during project execution for monitoring and control, or after project execution for organizational learning.

When trying to estimate the values of the criteria selected for use in the new BC, a BC developer may spend days on identifying criteria and defining methods, i.e., ways to put a qualitative, quantitative non-financial, or financial value on the identified criteria. This is especially hard when trying to identify components that define intangible benefits and indirect costs. Instead, criteria and methods may also come from databases which are specifically designed for the purpose of reuse, e.g., templates and taxonomies of criteria and methods with browse and query functionality for retrieval. BCD can be supported by a business case framework (BCF), which often comes in the form of a spreadsheet template with some pre-defined criteria and methods.

Today's BCFs are, however, often too generic, providing little support for BC developers who need to define domain-specific criteria and methods. Other times, BCFs are sufficiently domain-specific, but are based on templates and taxonomies, which are explicitly defined by domain experts. Such BCFs are expensive to develop and maintain and are therefore often limited to one domain. Further, today's business case frameworks (BCFs) are not based on a standardized model of what a BC is and how it can be developed. As a consequence, most BCFs and business cases (BC) are structured rather differently. This hampers the broader applicability of those BCFs and limits benchmarking and learning.

### SUMMARY

Various embodiments of systems and methods for dynamic reuse of business case components for business case development are described herein. In an aspect, the method involves receiving a sample criterion for creating a new business case. Further, a database of business cases is accessed, where one or more criteria associated with each of the business cases are hierarchically structured according to a common data model. The method further includes comparing the sample criterion with the criteria associated with the business cases in the database. Based on the comparison, one or more business cases in the database that have a criterion matching the sample criterion are identified. In another aspect, a position of the matching criterion in the hierarchical structure for each business case is determined. In another aspect, one or more criteria rendered alongside the matching criterion in the hierarchical structure are scored based on a position of the one or more criteria relative to the determined position. In yet another aspect, the one or more criteria are ranked based on the assigned scores, and a set of criteria are identified as additional criteria for the new business case, based on the ranking.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 illustrates a conceptual diagram of business case development by dynamic reuse of business case components technique, according to one embodiment.

FIG. 2 is a flow diagram of a method for business case development by dynamic reuse of business case components, according to one embodiment.

FIG. 3 illustrates an exemplary interface showing a criteria scoring process for business case development, in accordance with an embodiment.

FIG. 4 is a flow diagram illustrating a method for scoring business case criteria in a hierarchical structure and identifying additional criteria for business case development, according to one embodiment.

FIG. 5 illustrates an exemplary interface showing the business case development process, in accordance with an embodiment.

FIG. 6 is a block diagram of an exemplary system for business case development by dynamic reuse of business case components, according to one embodiment.

FIG. 7 is a block diagram of an exemplary computer system according to one embodiment.

### DETAILED DESCRIPTION

Embodiments of techniques for business case development by dynamic reuse of business case components are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

A business case (BC) is a recommendation to decision makers to take a particular course of action for an organization, supported by an analysis of benefits, costs and risks of each proposed alternatives. The analysis may be expressed in quantitative or qualitative, financial or non-financial terms. Business case development (BCD) is the process of realizing the business case as an ‘artifact,’ by gathering and analyzing data to define and valuate evaluation criteria, presenting it in documents, spreadsheets or presentations. BCD can be supported by a business case framework (BCF), which may be rendered in the form of a spreadsheet template with one or more predefined criteria, such as benefit, cost and risk factors that need to be considered during evaluation.

The dynamic reuse of business components technique supports the dynamic reuse of business components from existing business cases, while limiting the effort required to develop and maintain static databases of reusable components. The term “components” as used herein refers to business related criteria, methods, and/or values. The dynamic reuse of business case components is contrasted with the static reuse of business case components, in that, in the dynamic reuse approach, the reusable, domain-specific criteria and methods need not be pre-defined by experts in templates and taxonomies, but can be reused from earlier business cases. Instead, in the dynamic reuse approach, the business components that were developed and used for earlier business cases, when stored in a structured form and available for use, can be reused in a new business case based on a recommendation algorithm.

In an example scenario, a business case developer developing a new business case for radio frequency identification (RFID) may have to identify the business case components required to develop the new business case. Rather than defining all criteria from scratch, the developer may reuse criteria from earlier BCs using the dynamic reuse technique. The dynamic reuse technique is implemented in a business case development tool that is communicatively coupled to a data repository hosted by one or more data source systems. The data repository holds a database of business cases that were developed in the past. Further, the business cases in the database share a common data model such as hierarchically structured criteria. It should he noted, that the business cases in the database may cover several domains and organizations, and may be developed by other BC developers. In order to filter out relevant business cases from the database, the business case development tool compares a sample criterion input by the BC developer with the criteria associated with the business cases in the database.

In the given RFID example, the database may hold business cases related to barcodes, infra-red detectors, optic sensors, and RFID tags, among many others. In order to extract those business cases that may be relevant to the new business case for RFID, any one or more criteria input by the BC developer is used as a sample criterion for extracting the relevant BCs from the database. By comparing the sample criterion with the BCs in the database, those BCs that have a criterion matching the sample criterion are identified as relevant business cases. The relevant business cases may have one or more other criteria associated with the matching criterion that may be potentially relevant criteria for reusing in the new business case. In order to assess the relevancy of the one or more other criteria, a position of each of the one or more other criteria relative to the matching criterion in the hierarchical structure is determined. A score is assigned to each of the one or more other criteria based on its hierarchical position relative to the matching criterion. In an aspect, based on the assigned scores, the one or more criteria are ranked in either an increasing order or decreasing order of scores. The criteria that have a relatively high ranking are suggested to the BC developer as criteria for reuse in the new business case. For example, a top five criteria in the decreasing order (i.e., descending order) of ranking can be suggested as additional criteria. In another aspect, one or more criteria that have a score that meets a predefined threshold value are suggested as criteria for reuse in the new business case

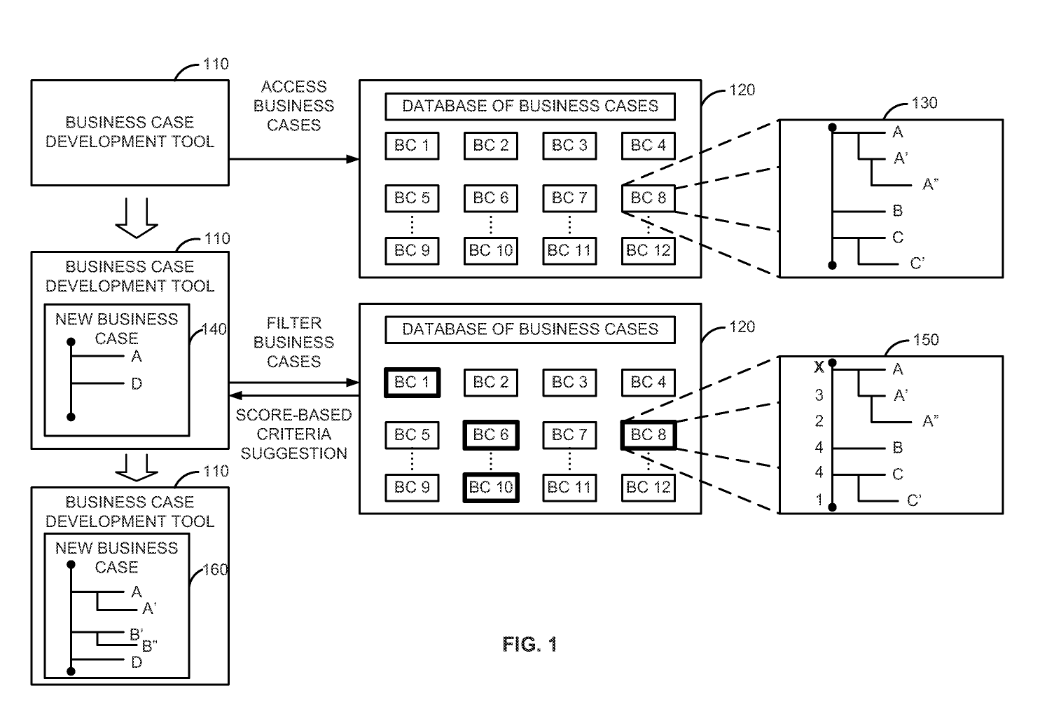

Referring to FIG. 1, a business case development tool 110 is communicatively coupled to a database of business cases 120. The database 120 holds several business cases (BC1 to BC12) that were developed earlier. In an aspect, the business cases are structured according to a common data model in which criteria in a business case are hierarchically structured. As shown in an exploded view 130 of BC 8, the criteria A, A′, A″, B, C, and C′ are hierarchically structured. Criteria A, A′, A″, B, C, and C′ may represent, for example, “ease of identification,’ ‘stock level,' ‘warehousing costs,’ etc. When a developer invokes the tool 110 to create a new business case 140, the tool 100 accesses the database of business cases 120. In order to filter out relevant business cases from the business cases BC1 to BC12, the developer may provide one or more criteria as sample criteria to the tool 110 via an input interface associated with the tool 110. In the given example, the tool 110 may receive criteria A and D as sample criteria. The tool 110 then compares the sample criterion A or D with the criteria associated with business cases BC1 to BC12 and identifies those business cases that have a criterion matching the sample criterion A or D. In the example shown, business cases BC1, BC6, BC8, and BC10 are identified as relevant business cases based on the comparison. In each of the identified business cases BC1, BC6, BC8, and BC10, the criteria other than the matching criterion are scored in order to identify criteria that may be potentially related to the new business case, for reuse. In an aspect, the other criteria are scored according to a relative position of each of the criteria with the matching criterion in the hierarchy. In the given example, as shown in the exploded view 150 of BC8, the other criteria A′, A″, B, C, and C′ associated with matching criterion A′ are assigned a score of 3, 2, 4, 4, and 1 respectively based on the hierarchical relation with the matching criterion A. Similarly, the criteria in the rest of the relevant business cases BC1, BC6, and BC10 are scored. For those criteria that occur in more than one of business cases BC1, BC6, BC8, and BC10, an aggregate of the scores assigned to each of the occurrences is calculated. Based on the aggregate scores, those criteria having a higher score may be suggested as criteria for reuse in the new business case. The suggested criteria may then be re-used in the new business cases 160 as shown.

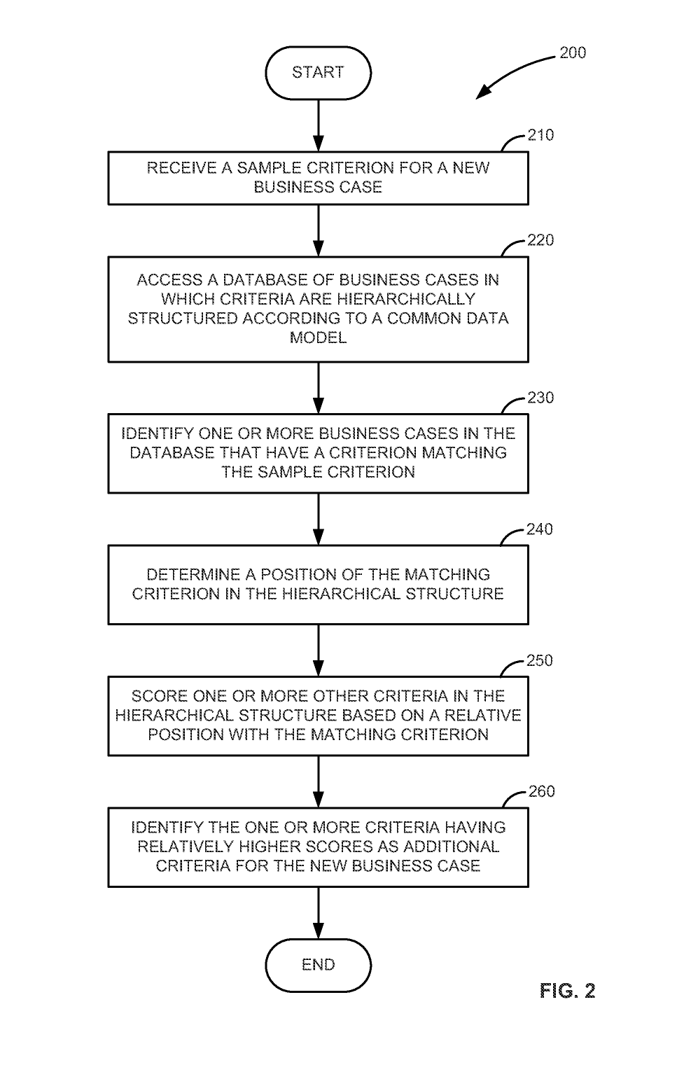

FIG. 2 illustrates a flow diagram of a method 200 for business case development by dynamically reusing business case components, according to an embodiment. The method 200, implemented by a computer or any other electronic device having processing capabilities, includes at least the following process illustrated with reference to process blocks 210-260. The business case development method involves dynamically reusing business case components from previously developed business cases. In an aspect, at process block 210, the business case development process is initiated upon receiving at least one criterion as a sample criterion for creating a new business case. A criterion is a business component that defines an information type. Examples of criteria include but are not limited to value proposition, deliverables, schedule, constraints, benefits, opportunities, impacts, contingencies, costs, stock levels, lean times, processing time, performance, customer satisfaction, resources, etc. The sample criterion acts as a starting point in the dynamic reuse of business case components process.

At process block 220, a database of business cases is accessed. The database holds a record of business cases that were developed in the past. In an aspect, the criteria associated with each of the business cases in the database are arranged in a hierarchical structure according to a common data model. In another aspect, the business components such as criteria and methods that were developed and used for already developed (existing) business cases are stored in the database according to a common data model defined by a business case ontology (BCO). The term “ontology” as used herein is defined as “a formal, explicit specification of a shared conceptualization.” An ontology is used to share a common understanding of the structure of information among different entities. In an example, the business case ontology is used to define a structure for the BCFs associated with the existing business cases such that the existing business cases are stored in the database of business cases according to a standardized data model. The already developed business cases refer to business cases that were developed at a time earlier than the time of creation of the new business case.

Upon accessing the database of business cases, the sample criterion is compared with the criteria associated with the business cases in the database. Based on the comparing, at process block 230, one or more business cases that have a criterion matching the sample criterion are identified. At process block 240, a position of the matching criterion in the hierarchical structure of the identified business cases is determined. As mentioned earlier, the criteria associated with each of the business cases are hierarchically structured according to a common data model. A position of the matching criterion in the hierarchical structure is defined by the order and the level at which the matching criterion appears in the hierarchy. Further, at process block 250, the associated criteria i.e., the other criteria that are rendered along with the matching criterion in the hierarchical structure, of a respective business case, are scored. The associated criteria may appear at a different level and branch than that of the matching criterion. In an aspect, each of the associated criteria is scored based on determining a relative position of each criterion with respect to the matching criterion.

In an example, a criterion on the same level as the matching criterion is termed “sibling” while a criterion appearing on a level from which the matching criterion branches from is termed “parent.” Similarly, a criterion appearing on a level from which the parent branches from is termed “grandparent.” Conversely, a criterion appearing on a level which branches from a level on which the matching criterion appears is termed “child” and a criterion appearing on a level which branches from a child of the matching criterion is termed “grandchild.” Different scores may be assigned to each of the other criteria based on the relation shared by each of the associated criteria and the matching criterion. In an example, criteria that are closer in the hierarchy to the place where the matching criterion appears may be assigned a higher score than criteria that are farther in the hierarchy to the place where the matching criterion appears. For example, siblings may be assigned 4 points, parents and children may be assigned 3 points, grandparents and grandchildren may be assigned 2 points and the rest of the criteria may be assigned 1 point each.

In an aspect, different weights may be assigned to the identified one or more business cases based on a relative age of the identified one or more business cases. For example, one or more of the identified business case may have been developed more recently than one or more other of the identified business cases. It is assumed that the more recent the business cases, the more relevant the associated criteria. In such instances, higher weightage can be assigned to the more recent business cases so that the associated criteria can be assigned a higher score during the scoring process. In an aspect, it is possible that some of the associated criteria also occur in multiple of the identified business cases, however at same or different positions in the hierarchy. In such instances, different scores may be assigned to each occurrence of a particular criterion in multiple identified business cases, depending on the respective hierarchical position. Thereafter, the particular criterion is scored by summing the different scores assigned to that particular criterion in the multiple business cases.

In another aspect, business cases in the real world may be heterogeneous and may include typos and nuances common to the natural language used to represent the business components. A literal matching of such components may yield sub-optimal results. For optimal results, a natural language processing algorithm may be used to enable intelligent matching of sample criterion with existing business case criteria as well as to matching criterion between existing business cases.

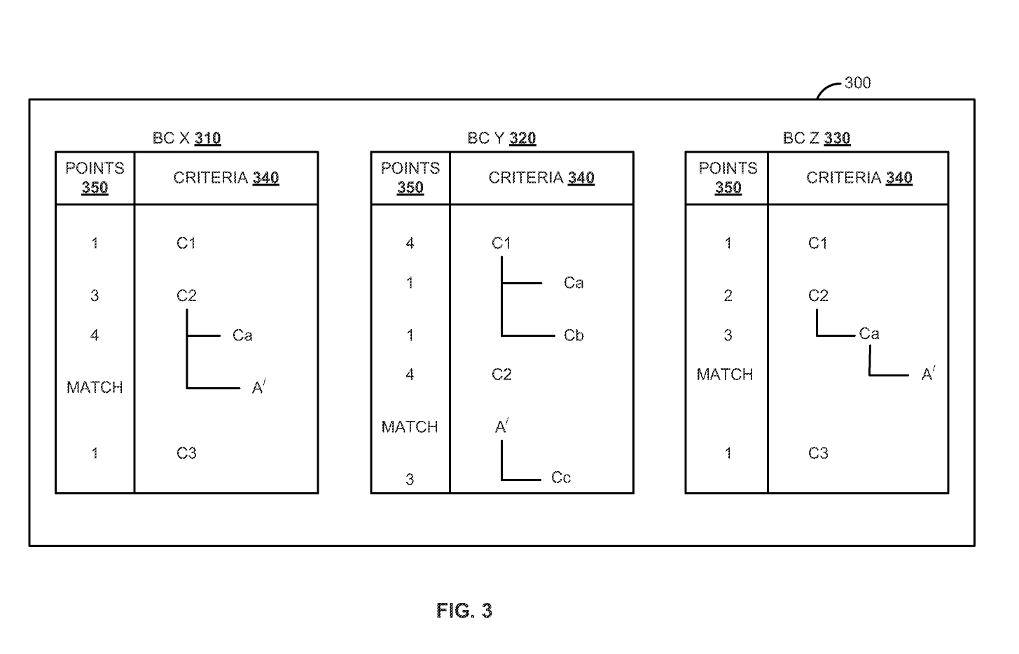

FIG. 3 illustrates an exemplary interface 300 showing the criteria scoring process for business case development, in accordance with an embodiment. In an example, a sample criterion A may have a matching criterion A′ in business cases X (310), Y (320), and Z (330). Business case X (310) has criteria C1, C2, and C3 with criteria Ca and A′ branching from C2. Business case Y (320) has criteria C1, C2, and A′ with criteria Ca and Cb branching from C1 and criterion Cc branching from matching criterion A′. Business case Z (330) has criteria C1, C2, and C3 with matching criterion A′ branching from Ca and criterion Ca branching from C2. Considering business case X (310), the criterion Ca is on the same level as matching criterion A′ and is a sibling to matching criterion A′. Ca is assigned the highest score of 4 while criterion C2 is a parent to matching criterion A′ and is assigned a score of 3. The remaining criteria C1 and C3 are assigned a score of 1 each. In business case Y (320), criterion Cc is a child of matching criterion A′ and is assigned a score of 3 while criteria C2 and C1 are on the same level as the matching criterion A′ and is assigned the highest score of 4. Similarly, in business case Z (330), criterion Ca is a parent to matching criterion A′ and is assigned a score of 3 while criterion C2 is a grandparent of matching criterion A′ and is assigned a score of 2. The remaining criteria C1 and C3 are assigned a score of 1 each.

An aggregate score for each of the criteria occurring along with the matching criterion A′ in the hierarchy is calculated by summing the scores assigned for the individual occurrences. In the given example, an aggregate score for criteria C1, C2, C3, Ca, Cb, and Cc is calculated as C1=1+4+1=6, C2=3+4+2=9, C3=1+1=2, Ca=4+1+3=8, Cb=1, and Cc=3. From the aggregated scores C1=6, C2=9, C3=2, Ca=8, Cb=1, and Cc=3, criteria C2 and Ca with the highest scores may be suggested as criteria for reuse in the new business case.

Referring back to FIG. 2, at process block 260, based on the aggregate scores for each of the associated criteria, one or more of the associated criteria are identified as additional criteria for developing the new business case. In an example, the one or more criteria are ranked according to the aggregate scores, and based on the ranking a set of criteria are identified as criteria for reuse. In another example, if one or more of the associated criteria have a score that meets a predefined value, then the one or more criteria are suggested as criteria that can be reused while developing the new business case. For example, those criteria that have a score of 3 or above can be identified as criteria for reuse.

In an aspect, when a sample criterion is provided multiple times for a new BC (it is possible to repeat criteria in the criteria hierarchy at different positions), all BCs having a matching criterion to the sample criterion are scored only once with respect to that criterion. However, when an existing BC's criteria match multiple different criteria in the new BC, all criteria in that existing BC are scored for each matching criterion. When a matching criterion occurs multiple times in an existing BC, the associated criteria are scored multiple times, based on its different positions in the hierarchy of the existing BC.

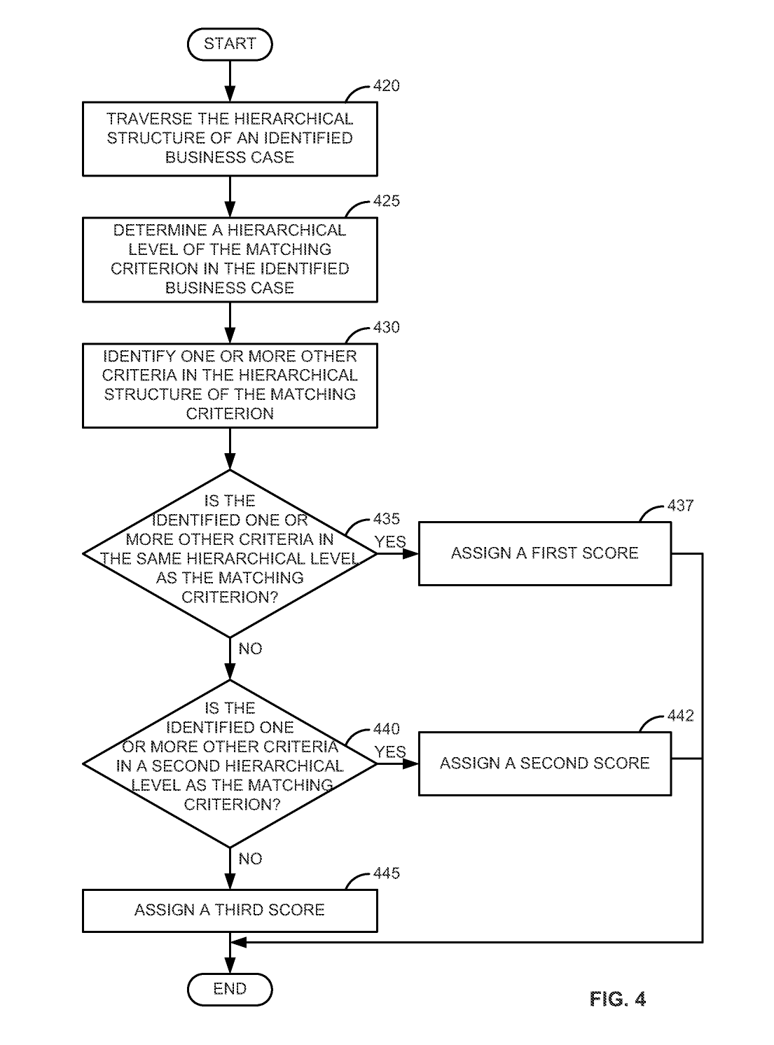

FIG. 4 is a flow diagram illustrating the criteria scoring process described with reference to process blocks 240-260 in FIG. 2, in more detail. In an aspect, the steps shown in process blocks 420-445 are performed consequent to identifying one or more business cases in the database as having a criterion matching the sample criterion. At process block 420, the hierarchical structure of the criteria associated with each of the identified one or more business cases are traversed. At process block 425, a hierarchical level, i.e., a position of the matching criterion in the hierarchical structure associated with each of the traversed business cases is determined. Herein, it is assumed that the BCFs for each of the business cases are structured according a common data model defined by a BCO. At process block 430, for each of the traversed business cases, one or more criteria that appear in the hierarchical structure in which the matching criterion appears are identified. At process block 435, it is determined whether the identified one or more criteria is at the same hierarchical level as the matching criterion. If so, a first score is assigned at process block 437. If not, it is determined whether the one or more criteria are at a second hierarchical level from the matching criterion. If so, a second score is assigned at process block 442. If not, a third score is assigned at process block 445. For example, if it is determined that the one or more criteria are a sibling to the matching criterion, then a high score of 4 is assigned. If not, it is determined whether, the one or more criteria are a parent or child to the matching criterion. If so, then a score of 3 is assigned. If not, a score of 2 is assigned for grandparent or grandchild. For any other level, a score of 1 is assigned.

In the example scenario, a business case on the use of barcodes for tracking parts in the supply chain already exists and is available for public access. Criteria in this existing BC may be ‘ease of identification’ (qualitative), ‘stock level’ (quantitative, non-financial) and ‘warehousing costs’ (financial). At a current time, the use of radio-frequency identification (RFID) make it easier for warehouse workers to collect data on stock levels faster and more efficiently, which may in turn make it possible to decrease warehousing costs. While developing a new BC for the use of radio-frequency identification (RFID), the BC developer has to decide on the various criteria to use in developing the new BC. Rather than defining all criteria from scratch, the developer may reuse criteria from earlier BCs. In this case, the criteria ‘ease of identification’, ‘stock level’ and ‘warehousing costs’ from the existing BC may also be relevant for the new BC for RFID.

In addition to the criteria, the methods used for the valuation of those criteria may be reused. The simplest way would be to use the same methods as used in the earlier BC. Especially when methods are reused, it is possible to compare the estimated values among BCs. For example, while investment in barcodes may have led to a 10% decrease of stock levels, the investment in RFID may only lead to another 2% decrease, at even higher implementation costs. Values may also be reused, e.g., within a certain industry, the average decrease of stock levels may be 3%. When developing the new BC one could then assume that the benchmark would be a realistic value for the new BC.

The reuse of criteria, methods, and values as presented in the above (simplified) scenario, is feasible if relevant BCs can be identified from a collection of existing BCs. Relevant BCs can be identified by comparing the criteria in the existing BCs with a sample criterion provided for developing a new BC. The BCs that have a matching criterion to the sample criterion are identified and further evaluated. For example, a score is assigned to each of the criteria in the identified business case depending on the proximity of the criteria to the matching criterion, within the hierarchical structure. A score is a specific type of a quantitative (non-financial) value. A score may be a number between a specified range such as 0 and 1 or between 1 and 5. Scoring methods are used to estimate a value when one wants to avoid calculating or measuring an exact value. Scores allow for easy comparison of cases and opinions of different stakeholders.

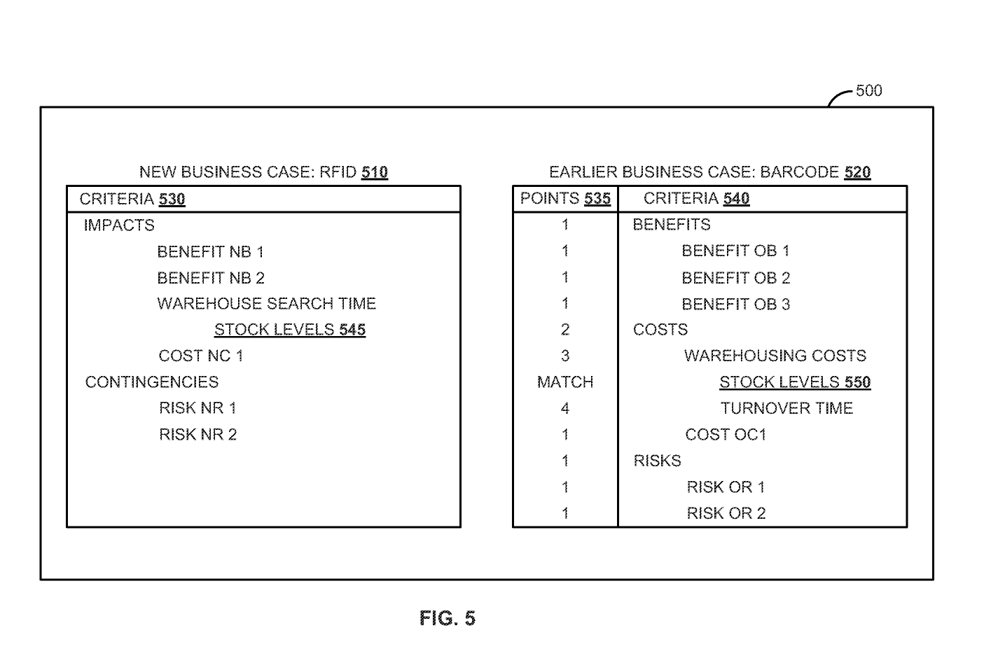

The process of dynamically reusing business components during business case development is illustrated, with reference to the given barcode-RFID example, in FIG. 5. FIG. 5 includes an interface 500 such as a graphical user interface showing a hierarchical representation of criteria relating to a new RFID business case 510 and an existing barcode business case 520. In the illustrated example, the criterion “stock levels” 540 in the new business case is configured as the sample criterion and serves as the starting point for the criteria scoring and selection process. Since the existing barcode business case 520 has “stock levels” 550 as one of its criterion, the barcode BC 520 is identified as a relevant BC. The associated criteria such as “Benefits,” “Costs,” “Risks” etc., that are rendered alongside the matching criterion “stocks level” 550, are scored. In an aspect, the criteria in the barcode BC 520 are structured according to a BC ontology. The associated criteria in the barcode BC 520 is scored according to the relative position of each criterion to the matching criterion in the hierarchy. As shown in the points field 535, the criterion “turnover time” is a sibling to the matching criterion “stock levels” 550 and is assigned a score of 4. The criterion “warehousing costs” is a parent of the matching criterion “stock levels” 550 and is assigned a score of 3. The criterion “Costs” is a grandparent of the matching criterion “stock levels” 550 and is assigned a score of 2. The rest of the criteria are assigned a score of 1 each.

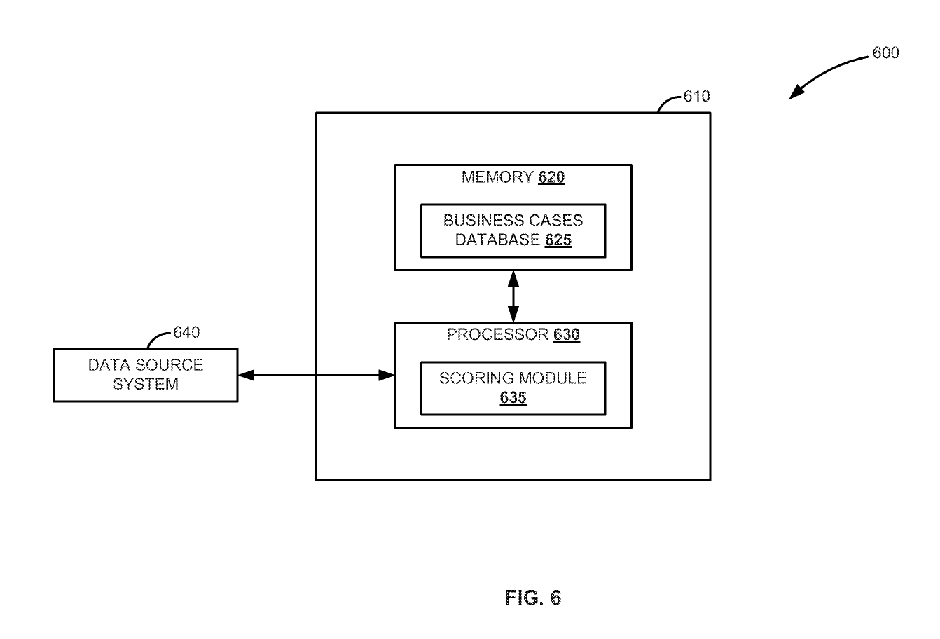

FIG. 6 is a block diagram of an exemplary system for business case development by dynamic reuse of business case components, according to one embodiment. The system 600 may be communicatively coupled to one or more data source systems. Data source systems 640 refer to sources of data that enable data storage and/or retrieval. For example, data source system 640 may include databases, web applications, web server, a reporting tool, data server etc. Examples of databases include relational, transactional, hierarchical, multi-dimensional (e.g., OLAP), object oriented databases, and the like. Data source systems 640 may also include a data source where the data is not tangibly stored or otherwise ephemeral such as data streams, broadcast data, and the like.

In an embodiment, the system 600 includes a computer 610 having a processor 630 and memory 620. The processor 630 executes software instructions or code for business case development by dynamic reuse of business case components, stored on a computer readable storage medium such as the memory 620, to perform the above-illustrated methods. The system 600 includes a media reader to read the instructions from the computer readable storage medium 620 and store the instructions in storage or in random access memory (RAM). For example, the computer readable storage medium 620 includes executable instructions for performing operations including, but not limited to, receiving a sample criterion for a new business case being developed, accessing a database of business cases to identify business cases having a matching criterion to the sample criterion, scoring the associated criteria in the relevant business cases and suggesting criteria for reusing in the new business case, based on the scoring.

In an aspect, the memory 620 holds a database 625 of existing business cases including BCs collected through the data source systems. The existing business cases refer to the business cases that were already developed and are available for access. The existing business cases may have been developed by a different developer(s) from a different domain/organization. Further, the existing business cases are not domain specific and are not assigned to particular templates or taxonomies.

In an aspect, the processor 630 employs a collaborative filtering technique for identifying potentially related criteria for reuse from the existing BCs. The processor 630 may invoke the database 625 from the memory 620 in response to receiving a sample criterion for the new business case. Alternatively, the processor 630 may invoke the database 625 when one of the criteria in the new BC that is being developed is configured as a sample criterion. The processor 630 then compares the sample criterion with the existing BCs in the database 625 and determines whether a matching criterion appears in any of the existing BCs. If one or more of the existing BCs are determined to have a matching criterion, then a scoring module 635 of the processor 630 proceeds to score the other criteria that are rendered along with the matching criterion. Based on the scoring, the scoring module identifies one or more criteria as potential candidate criteria for reusing in the new BC being developed.

Some of the above described embodiments improve the usefulness and usability of business case frameworks (BCFs), while limiting the effort required developing and maintaining static databases of reusable components. The approach facilitates the dynamic reuse of business case components and is contrasted with static reuse of business case components possibly developed by other BC developers, possibly working for different organizations. In the dynamic approach, the reusable, domain-specific criteria and methods do not need to be pre-defined by experts in templates and taxonomies, but can be reused from earlier business cases. The dynamic reuse of BC components is in contrast to the static reuse of BC components in that components such as criteria and methods that were developed and used for earlier BCs, when stored in some structured database, can be reused in new BCs on the basis of a recommendation algorithm. The approach assumes that the earlier BCs share a common data model and are publicly accessible, possibly in an anonymized or aggregated form. To select criteria and methods automatically from earlier BCs for reuse, a mechanism, such as collaborative filtering is employed as discussed in some of the embodiments.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

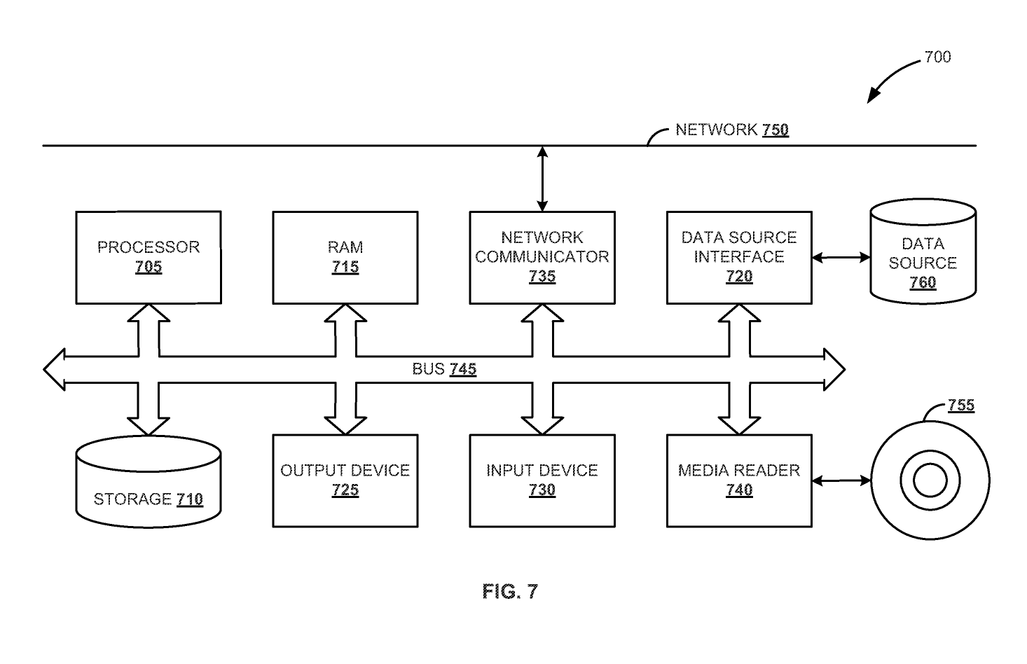

FIG. 7 is a block diagram of an exemplary computer system 700. The computer system 700 includes a processor 705 that executes software instructions or code stored on a computer readable storage medium 755 to perform the above-illustrated methods of the invention. The computer system 700 includes a media reader 740 to read the instructions from the computer readable storage medium 755 and store the instructions in storage 710 or in random access memory (RAM) 715. The storage 710 provides a large space for keeping static data where at least some instructions could be stored for later execution. The stored instructions may be further compiled to generate other representations of the instructions and dynamically stored in the RAM 715. The processor 705 reads instructions from the RAM 715 and performs actions as instructed. According to one embodiment of the invention, the computer system 700 further includes art output device 725 (e.g., a display) to provide at least some of the results of the execution as output including, but not limited to, visual information to users and an input device 730 to provide a user or another device with means for entering data and/or otherwise interact with the computer system 700. Each of these output devices 725 and input devices 730 could be joined by one or more additional peripherals to further expand the capabilities of the computer system 700. A network communicator 735 may be provided to connect the computer system 700 to a network 750 and in turn to other devices connected to the network 750 including other clients, servers, data stores, and interfaces, for instance. The modules of the computer system 700 are interconnected via a bus 745. Computer system 700 includes a data source interface 720 to access data source 760. The data source 760 can be accessed via one or more abstraction layers implemented in hardware or software. For example, the data source 760 may be accessed by network 750. In some embodiments the data source 760 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text tiles), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

1. A computer implemented method in a Business Case development system, the method comprising:
receiving a sample criterion for developing a new business case;
accessing a database of business cases formed by criteria that are hierarchically structured according to a common data model;
identifying, by the computer, one or more business cases in the database that have a criterion matching the sample criterion;
determining, by the computer, a position of the matching criterion in the hierarchical structure associated with the identified one or more business cases;
scoring, by the computer, one or more other criteria associated with the matching criterion, in the hierarchical structure, based on a relative position with the matching criterion;
ranking the one or more other criteria based on the scoring; and
presenting a set of the one or more other criteria as additional criteria for the new business case, based on the ranking.

2. The method of claim 1, wherein scoring the one or more other criteria comprises assigning a score to the one or more other criteria based on a proximity of the one or more other criteria to the matching criterion in the hierarchical structure.

3. The method of claim 2, wherein a higher score is assigned to the at least one of the one or more other criteria that are closer in hierarchy to the matching criterion compared to other of the one or more other criteria in the hierarchy.

4. The method of claim 1, wherein scoring the one or more other criteria further comprises determining an aggregate of scores of the one or more other criteria occurring in multiple of the identified one or more business cases.

5. The method of claim 1, further comprising presenting the one or more other criteria whose score meets a predefined threshold limit as the additional criteria.

6. The method of claim 1, further comprising assigning different weights to the identified one or more business cases based on a relative age of the identified one or more business cases.

7. The method of claim 1, wherein the hierarchical structure is formed of one or more branches and sub-branches representing the one or more criteria.

8. The method of claim 7, wherein different scores are assigned to the one or more branches and sub-branches based on a hierarchical level of a branch or sub-branch representing the matching criterion.

9. An article of manufacture, comprising:
a computer readable storage medium having instructions which when executed by a computer causes the computer to:
receive a sample criterion for developing a new business case;
access a database of business cases formed by criteria that are hierarchically structured according to a common data model;
identify one or more business cases in the database that have a criterion matching the sample criterion;
score one or more other criteria associated with the matching criterion in the hierarchical structure, based on a relative position with the matching criterion; and
present the one or more other criteria having a predefined score as additional criteria for the new business case.

10. The article of manufacture of claim 9, wherein scoring the one or more other criteria comprises assigning a score to the one or more other criteria based on a proximity of the one or more other criteria to the matching criterion in the hierarchical structure.

11. The article of manufacture of claim 10, wherein a higher score is assigned to at least one of the one or more criteria that is closer in hierarchy to the matching criterion compared to other of the one or more other criteria in the hierarchy.

12. The article of manufacture of claim 9, wherein scoring the one or more other criteria further comprises determining an aggregate of scores of the one or more other criteria occurring in multiple of the identified one or more business cases.

13. The article of manufacture of claim 9, wherein presenting the one or more other criteria having the predefined score as additional criteria comprises identifying one or more other criteria whose score meets a predefined threshold limit as the additional criteria.

14. The article of manufacture of claim 9, wherein the one or more other criteria include at least one of financial criteria, management criteria, and development criteria.

15. The article of manufacture of claim 9, wherein the business cases are hierarchically structured according to a common business case ontology.

16. The article of manufacture of claim 9, wherein the database comprises a record of existing business cases.

17. The article of manufacture of claim 9, wherein the hierarchical structure is formed of one or more branches and sub-branches representing one or more criteria.

18. The article of manufacture of claim 17, wherein different scores are assigned to the one or more branches based on a relevance of the one or more branches to a branch representing the matching criterion.

19. A system comprising:
a data source system; and
a computer comprising a memory to store a program code, and a processor to execute the program code to:
receive a sample criterion for developing a new business case;
access a database of existing business cases formed by criteria that are hierarchically structured according to a common data model;
identify one or more business cases in the database that have a criterion matching the sample criterion;
score one or more other criteria associated with the matching criterion based on a hierarchical ranking of the one or more other criteria relative to the matching criterion; and
present the one or more other criteria having a predefined score as additional criteria for the new business case.

20. The system of claim 19, wherein the data source system includes at least one of a web service, a datamart, an integrated ERP system, and external feed.
